(19) United States
(12) Patent Application Publication
(10) Pub. No.: US 2009/0129597 A1
(43) Pub. Date: May 21, 2009

(54) REMOTE PROVISIONING UTILIZING DEVICE IDENTIFIER

(76) Inventors: Vincent J. Zimmer, Federal Way, WA (US); Michael A. Rothman, Puyallup, WA (US)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/943,969

(22) Filed: Nov. 21, 2007

(51) Int. Cl. H04L 9/30; H04L 9/00; G06F 21/00

(52) U.S. Cl. 380/277; 713/151; 713/155

(57) ABSTRACT

Embodiments of the present invention provide for remote provisioning using a device identifier. In some embodiments, a client device may transmit the device identifier to a provisioning server and, sometime after an association of the device identifier and the client device has been authenticated, receive an operating system boot image from the provisioning server. Other embodiments may be described and claimed.

### FIELD

Embodiments of the present invention relate to the field of remote provisioning.

### BACKGROUND

Integrating new servers into an enterprise network typically requires that an information technology (IT) technician manually plug in a boot device to the new servers and manipulate the new servers at local consoles. While this method of provisioning a server works reasonably well with a couple of servers, this requires significant resources in the integration of a large number of distributed servers.

Remote provisioning has been provided through procedures detailed in preboot execution environment (PXE) Version 2.1, Intel Corporation, published Sep. 20, 1999 (hereinafter “PXE 2.1”). These procedures provide that a PXE boot server boots a PXE client over a network. PXE 2.1 procedures utilize unique identifying information of the PXE client, e.g., a globally unique identifier (GUID) and/or a universally unique identifier (UUID), so that a dynamic host configuration protocol (DHCP) may recognize the PXE client and provide the PXE client with an internet protocol (IP) address. The PXE client may then retrieve an operating system (OS) boot image from the PXE boot server. This process is usually performed in a closed network due to security concerns related to the integrity and authenticity of the OS boot image.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 illustrates a remote provisioning environment in accordance with various embodiments of the present invention;

FIG. 2 is a flowchart illustrating operations of a PXE client in accordance with various embodiments of the present invention;

FIG. 3 is a flowchart illustrating operations of a PXE boot server in accordance with various embodiments of the present invention; and

FIG. 4 illustrates a computing device in accordance with various embodiments of this invention.

### DETAILED DESCRIPTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

For the purposes of the present invention, the phrase “A and/or B” means “(A), (B), or (A and B).” For the purposes of the present invention, the phrase “A, B, and/or C” means “(A), (B), (C), (A and B), (A and C), (B and C), or (A, B and C).”

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

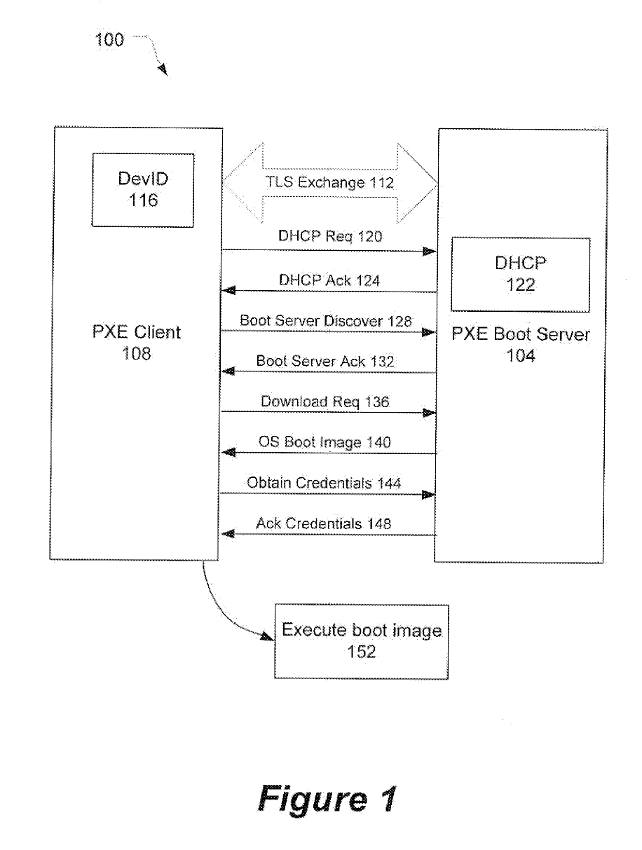

FIG. 1 illustrates a remote provisioning environment, e.g., environment 100, in accordance with various embodiments of the present invention. As used herein, “remote provisioning” may refer to a boot server, e.g., PXE boot server 104, providing a client device, e.g., a PXE client 108, with an OS boot image over a network connection. The client device 108 may be a server, a desktop computing device, a laptop computing device, a mobile computing device, etc. The “client” designation may simply refer to the role of the client device 108 in the provisioning procedure and does not otherwise restrict embodiments of the present invention.

The remote provisioning may be initiated with the PXE boot server 104 and the PXE client 108 engaging in a transport layer security (TLS) exchange 112. The TLS exchange 112 may be a layer 2 exchange wherein the PXE client 108 provides the PXE boot server 104 with a device identifier (hereinafter “devID”) 116 and the PXE boot server 104 authenticates an association of the devID 116 with the PXE client 108. A layer 2 exchange may encapsulate transport layer information directly in data link layer, bypassing network layer services.

The devID 116 may generically identify the PXE client 108 as being a device of a class of devices. For example, the devID may indicate that the PXE client 108 is a server of a particular make and model. The PXE boot server 104 may have received information out of band (OOB), e.g., through an IT technician entering devIDs off of a bill of materials (or from a vendor's website, etc.), that may be used to verify that a client device involved in a remote provisioning procedure is indeed a device that is being integrated into a vendor's infrastructure. This verification may provide the foundation for building a secure association between the PXE boot server 104 and the PXE client 108 to allow an OS boot image to be passed to the PXE client 108 in a reliable manner.

The generic nature of the devID 116 may allay privacy concerns associated with transmission of a unique identifier (e.g., the GUID/UUID), which may disclose personally identifiable information (PII).

The devID 116 may be associated with the PXE client 108 at the manufacture of the PXE client 108 by being bound to the hardware of the PXE client 108. In various embodiments the devID may reside in a processing unit, a chipset (e.g., a trusted platform module (TPM)), a network interface card (NIC), etc. The devID 116 may include a secret part and a public part. The public part may include various information about credentials of the devID 116, e.g., version, serial number, signature, issuer, validity dates, public keys information, etc. The private part may include a cryptographically secure secret, anchored to the PXE client 108, that may be used in various cryptographic operations. In various embodiments, the devID 116 may be compatible with definitions provided in the 802.1ar standard titled “Secure Device Identity,” which is currently being developed by the Institute of Electrical and Electronics Engineers (IEEE).

After the TLS exchange 112, the PXE client 108 may request an IP address by issuing a DHCP request 120 to a DHCP server 122, which may be part of the boot server 104 as shown, or a separate server in other embodiments. The DHCP server 122 may respond by providing an IP address in a DHCP acknowledgment message 124.

While the TLS exchange 112 can be done after the IP address is procured, as a layer 3 exchange, doing it beforehand may avoid security vulnerabilities resulting from a compromised DHCP server.

After the PXE client 108 obtains an IP address, it may transmit a boot server discover message 128 to determine whether the PXE boot server 104 is available. When available, the PXE boot server 104 may respond with a boot server acknowledgment message 132.

The PXE client 108 may request the OS boot loader in a download request 136. The PXE boot server 104 may respond by transmitting an OS boot image 140.

The PXE client 108 may request credentials from the PXE boot server 104 through an obtain credentials message 144. The PXE boot server 104 may respond with an acknowledge credentials message 148. The credentials from the PXE boot server 104 may be a signed manifest containing verification information for an indicated data object.

The PXE client 108, having received the OS boot image and credentials may execute the boot image 152.

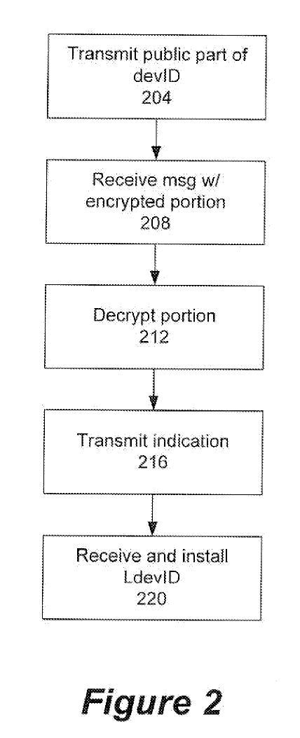

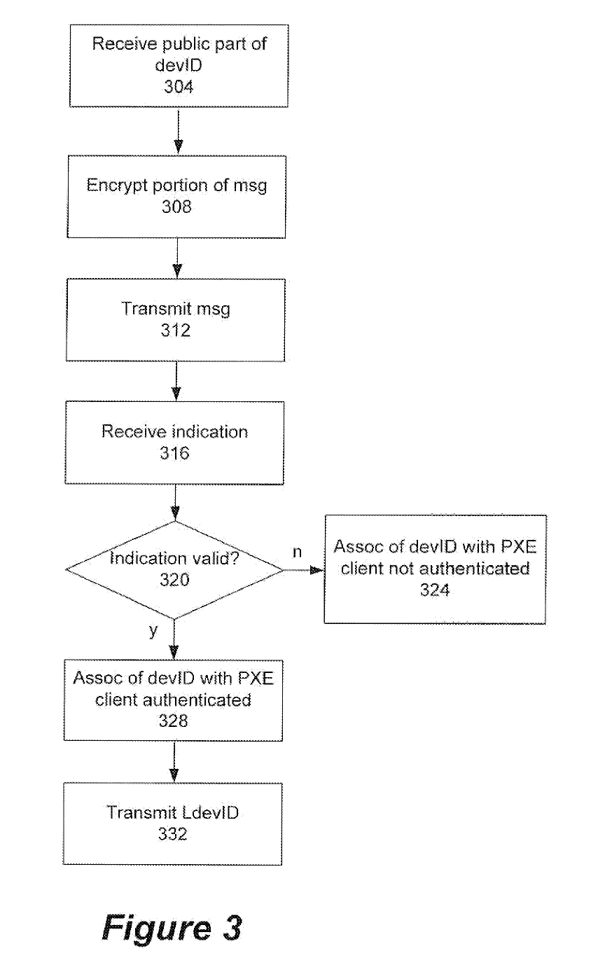

FIGS. 2 and 3 are flowcharts respectively illustrating operations of the PXE client 108 and the PXE boot server 104 in the TLS exchange 112 in accordance with various embodiments. In block 204, the PXE client 108 may initiate the TLS exchange 112 by transmitting the devID 116 to the PXE boot server 104. In particular, and in accordance with an embodiment, the PXE client 108 may transmit a public part of the devID 116 to the PXE boot server 104.

In block 304, the PXE boot server 104 may receive the public part of the devID 116 and, in block 308, use the public part of the devID 116 to encrypt at least a portion of a message transmitted to the PXE client 108 in block 312. The encrypted portion of the message may sometimes be referred to as a challenge.

In block 208, the PXE client 108 may receive the message and use a private part of the devID 116 to decrypt the encrypted portion in block 212. The PXE client 108 may then transmit an indication of the successful decryption of the portion to the PXE boot server 104 in block 216.

In block 316, the PXE boot server 104 may receive the transmitted indication and determine whether it is valid in block 320. The PXE boot server 104 may use a public key portion of the public part of the DevID to validate this transmitted indication.

If the indication is not valid, the PXE boot server 104 may not authenticate the association of the devID with the PXE client 108 in block 324. If the indication is valid, the association may be authenticated in block 328 and the PXE boot server 104 may transmit a local devID (LdevID) in block 332. An LdevID may be a unique ID that is enterprise specific.

In block 220, the PXE client 108 may receive and install the LdevID. Once installed on the PXE client 108, the LdevID may usurp the devID 116. By providing the LdevID in this manner, the PXE boot server 104 may, in effect, remotely take ownership of the PXE client 108.

In addition (or as an alternative) to determining whether the devID is properly associated with the PXE client 108, the PXE boot server 104 may determine the validity of the devID 116 itself. This may be determined by referencing information transmitted directly in the public part of the devID 116, e.g., validity time frame, and/or by OOB information, e.g., information on revocations, updates, etc., that apply to the devID 116.

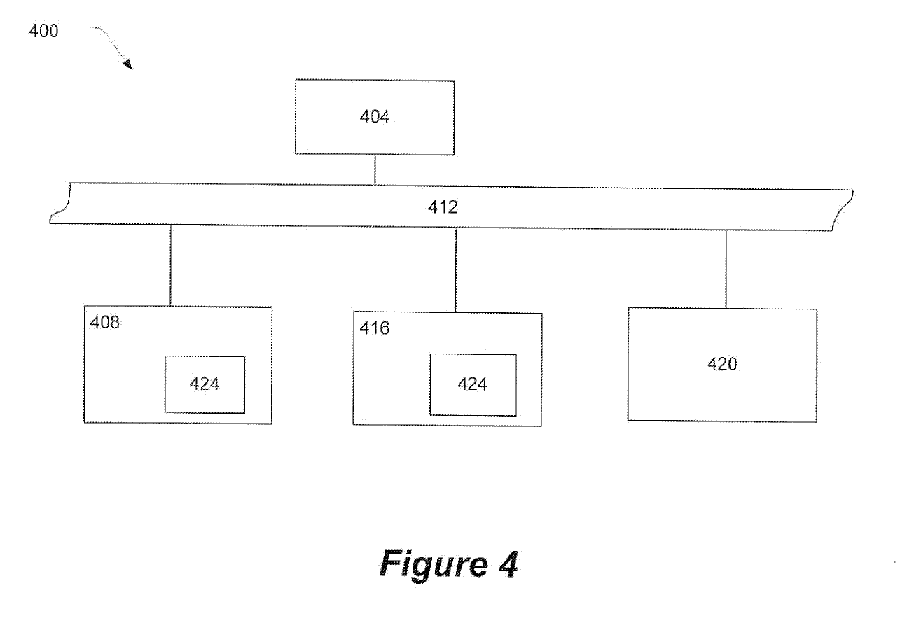

FIG. 4 illustrates a computing device 400 capable of implementing a PXE computing device in accordance with various embodiments. As illustrated, for the embodiments, computing device 400 includes processor 404, memory 408, and bus 412, coupled to each other as shown. Additionally, computing device 400 includes storage 416, and communication interfaces 420, e.g., a wireless network interface card (WNIC), coupled to each other, and the earlier described elements as shown.

Memory 408 and storage 416 may include in particular, temporal and persistent copies of provisioning logic 424, respectively. The provisioning logic 424 may include instructions that when executed by the processor 404 results in a provisioning agent being implemented that performs remote provisioning operations described in conjunction with various PXE devices, e.g., the PXE boot server and/or the PXE client, in accordance with embodiments of this invention. These remote provisioning operations include, but are not limited to, a PXE boot server remotely provisioning a PXE client with an OS boot image and a PXE client being remotely provisioned by a PXE boot server.

In various embodiments, the memory 408 may include RAM, dynamic RAM (DRAM), static RAM (SRAM), synchronous DRAM (SDRAM), dual-data rate RAM (DDRRAM), etc.

In various embodiments, the processor 404 may include one or more single-core processors, multiple-core processors, controllers, application-specific integrated circuits (ASICs), etc.

In various embodiments, storage 416 may be a machine-accessible medium that includes integrated and/or peripheral storage devices, such as, but not limited to, disks and associated drives (e.g., magnetic, optical), universal serial bus (USB) storage devices and associated ports, flash memory, read-only memory (ROM), nonvolatile semiconductor devices, etc.

In various embodiments, storage 416 may be a storage resource physically part of the computing device 400 or it may be accessible by, but not necessarily a part of, the computing device 400. For example, the storage 416 may be accessed by the computing device 400 over a network.

In various embodiments, computing device 400 may have more or less components, and/or different architectures.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. This application is intended to cover any adaptations or variations of the embodiments discussed herein. Therefore, it is manifestly intended that embodiments in accordance with the present invention be limited only by the claims and the equivalents thereof.

What is claimed is:

1. A machine-accessible medium having associated instructions that, when executed, results in a machine:
transmitting, to a provisioning server, a device identifier that generically identifies a device as being one of a class of devices;
receiving, from the provisioning server, a message that includes at least a portion encrypted based at least in part on the device identifier;
decrypting at least the portion of the message;
transmitting, to the provisioning server, an indication that at least the portion was successfully decrypted to authenticate an association of the device identifier with the device; and
receiving, from the provisioning server, an operating system boot image.

2. The machine-accessible medium of claim 1, wherein the device identifier is associated with the device when the device is manufactured.

3. The machine-accessible medium of claim 1, wherein the associated instructions, when executed, further result in the machine:
receiving, after transmission of the indication and prior to receipt of the operating system boot image, a local device identifier that uniquely identifies the device within an enterprise.

4. The machine-accessible medium of claim 3, wherein the associated instructions, when executed, further results in the machine installing the local device identifier on the machine.

5. The machine-accessible medium of claim 1, wherein the associated instructions, when accessed, further result in the machine:
transmitting, after transmission of the device identifier, a dynamic host configuration protocol request to request an internet protocol address.

6. The machine-accessible medium of claim 1, wherein the associated instructions are configured to be executed by a machine in a preboot execution environment.

7. The machine-accessible medium of claim 1, wherein said transmitting the device identifier, receiving the message, transmitting the indication, and receiving the operating system boot image comprise a transport layer security exchange.

8. An apparatus comprising:
a communication interface configured to communicatively couple the apparatus to a network; and
a provisioning agent coupled to the communication interface and configured to engage a provisioning server, via the communication interface, in a transport layer security exchange in which the provisioning agent provides a device identifier that identifies the apparatus as being one of a class of devices, authenticates an association of the device identifier with the apparatus, and receives, upon successful authentication of the association, a local device identifier that uniquely identifies the device within an enterprise.

9. The apparatus of claim 8, wherein the device identifier is associated with the apparatus when the apparatus is manufactured.

10. The apparatus of claim 8, wherein the provisioning agent is further configured to receive an operating system boot image from the provisioning server.

11. The apparatus of claim 8, wherein the transport security layer exchange is to occur within a preboot execution environment.

12. The apparatus of claim 8, wherein the provisioning agent is further configured to receive, from the provisioning server, a message that includes at least a portion encrypted based at least in part on the device identifier; to decrypt at least the portion of the message; and to transmit, to the provisioning server, an indication that at least the portion was successfully decrypted to authenticate the association of the device identifier with the apparatus.

13. The apparatus of claim 8, wherein the device identifier generically identifies the apparatus as being one of a class of devices.

14. A method comprising:
receiving, from a device, a device identifier that generically identifies the device as being one of a class of devices;
encrypting at least a portion of a message based at least in part on the device identifier;
transmitting the message to the device;
receiving, from the device, an indication that at least the portion was successfully decrypted;
authenticating an association of the device identifier with the device based at least in part on the indication; and
transmitting, to the device, an operating system boot image based at least in part on said authenticating the association.

15. The method of claim 14, further comprising:
remotely taking ownership of the device.

16. The method of claim 15, wherein said remotely taking ownership comprises:
transmitting, after receiving the indication and prior to transmitting the operating system boot image, a local device identifier that uniquely identifies the device within the enterprise.

17. The method of claim 14, wherein said receiving the device identifier, transmitting the message, and receiving the indication comprise a transport level security exchange.

18. The method of claim 14, further comprising:
receiving, after said authenticating the association, a dynamic host configuration protocol (DHCP) request; and
transmitting a DHCP acknowledgment providing an internet protocol address.

19. The method of claim 14, further comprising:
referencing a public key portion; and
determining the validity of the device identifier based at least in part on said referencing of the public key portion.

20. The method of claim 19, wherein the public key portion is distributed via a vendor's website and/or a bill of material.
